(19) United States
(12) Patent Application Publication
(10) Pub. No.: US 2013/0325767 A1
(43) Pub. Date: Dec. 5, 2013

(54) DYNAMICAL EVENT NEURON AND SYNAPSE MODELS FOR LEARNING SPIKING NEURAL NETWORKS

(71) Applicant: Jason Frank Hunzinger, Escondido, CA (US)

(72) Inventor: Jason Frank Hunzinger, Escondido, CA (US)

(73) Assignee: QUALCOMM Incorporated, San Diego, CA (US)

(21) Appl. No.: 13/483,811

(22) Filed: May 30, 2012

(51) Int. Cl. G06N 3/02

(52) U.S. Cl. CPC G06N 3/02
USPC 706/16

(57) ABSTRACT

Certain aspects of the present disclosure provide methods and apparatus for a continuous-time neural network event-based simulation. This model is flexible, has rich behavioral options, can be solved directly, and is low complexity. One example method generally includes determining a first state of a neuron model at or shortly after a first event, wherein the neuron model has a closed-form solution in continuous time; and determining a second state of the neuron model at or shortly after a second event, based on the first state. Dynamics of the first and second states are coupled to the neuron model only at the first and second events, respectively, and are decoupled between the first and second events.

### BACKGROUND

1. Field

Certain aspects of the present disclosure generally relate to neural networks and, more particularly, to a continuous-time, event-based model for neurons and synapses.

2. Background

An artificial neural network is a mathematical or computational model composed of an interconnected group of artificial neurons (i.e., neuron models). Artificial neural networks may be derived from (or at least loosely based on) the structure and/or function of biological neural networks, such as those found in the human brain. Because artificial neural networks can infer a function from observations, such networks are particularly useful in applications where the complexity of the task or data makes designing this function by hand impractical.

One type of artificial neural network is the spiking neural network, which incorporates the concept of time into its operating model, as well as neuronal and synaptic state, thereby increasing the level of realism in this type of neural simulation. Spiking neural networks are based on the concept that neurons fire only when a membrane potential reaches a threshold. When a neuron fires, it generates a spike that travels to other neurons which, in turn, raise or lower their membrane potentials based on this received spike.

### SUMMARY

Certain aspects of the present disclosure generally relate to a continuous-time neural network event-based simulation. This model is flexible, has rich behavioral options, can be solved directly, and is low complexity.

Certain aspects of the present disclosure provide a method for neural networks. The method generally includes determining a first state of a neuron model, wherein the neuron model has a closed-form solution in continuous time and wherein state dynamics of the neuron model are divided into two or more regimes; and determining an operating regime for the neuron model from the two or more regimes, based on the first state.

Certain aspects of the present disclosure provide an apparatus for neural networks. The apparatus generally includes a processing system configured to determine a first state of a neuron model, wherein the neuron model has a closed-form solution in continuous time and wherein state dynamics of the neuron model are divided into two or more regimes; and to determine an operating regime for the neuron model from the two or more regimes, based on the first state.

Certain aspects of the present disclosure provide an apparatus for neural networks. The apparatus generally includes means for determining a first state of a neuron model, wherein the neuron model has a closed-form solution in continuous time and wherein state dynamics of the neuron model are divided into two or more regimes; and means for determining an operating regime for the neuron model from the two or more regimes, based on the first state.

Certain aspects of the present disclosure provide a computer-program product for neural networks. The computer-program product generally includes a computer-readable medium having instructions executable to determine a first state of a neuron model, wherein the neuron model has a closed-form solution in continuous time and wherein state dynamics of the neuron model are divided into two or more regimes; and to determine an operating regime for the neuron model from the two or more regimes, based on the first state.

Certain aspects of the present disclosure provide a method for neural networks. The method generally includes determining a first state of a neuron model at or shortly after a first event, wherein the neuron model has a closed-form solution in continuous time; and determining a second state of the neuron model at or shortly after a second event, based on the first state, wherein dynamics of the first and second states are coupled to the neuron model only at the first and second events, respectively, and are decoupled between the first and second events.

Certain aspects of the present disclosure provide an apparatus for neural networks. The apparatus generally includes a processing system configured to determine a first state of a neuron model at or shortly after a first event, wherein the neuron model has a closed-form solution in continuous time; and to determine a second state of the neuron model at or shortly after a second event, based on the first state, wherein dynamics of the first and second states are coupled to the neuron model only at the first and second events, respectively, and are decoupled between the first and second events.

Certain aspects of the present disclosure provide an apparatus for neural networks. The apparatus generally includes means for determining a first state of a neuron model at or shortly after a first event, wherein the neuron model has a closed-form solution in continuous time; and means for determining a second state of the neuron model at or shortly after a second event, based on the first state, wherein dynamics of the first and second states are coupled to the neuron model only at the first and second events, respectively, and are decoupled between the first and second events.

Certain aspects of the present disclosure provide a computer-program product for neural networks. The computer-program product generally includes a computer-readable medium having instructions executable to determine a first state of a neuron model at or shortly after a first event, wherein the neuron model has a closed-form solution in continuous time; and to determine a second state of the neuron model at or shortly after a second event, based on the first state, wherein dynamics of the first and second states are coupled to the neuron model only at the first and second events, respectively, and are decoupled between the first and second events.

Certain aspects of the present disclosure provide a method for neural networks. The method generally includes determining a first state of a neuron model at or shortly after a first event, wherein the neuron model has a closed-form solution in continuous time; and determining a second event when, if ever, a second state of the neuron model will occur, based on the first state, wherein dynamics of the first and second states are coupled to the neuron model only at the first and second events, respectively, and are decoupled between the first and second events.

Certain aspects of the present disclosure provide an apparatus for neural networks. The apparatus generally includes a processing system configured to determine a first state of a neuron model at or shortly after a first event, wherein the neuron model has a closed-form solution in continuous time; and to determine a second event when, if ever, a second state of the neuron model will occur, based on the first state, wherein dynamics of the first and second states are coupled to the neuron model only at the first and second events, respectively, and are decoupled between the first and second events.

Certain aspects of the present disclosure provide an apparatus for neural networks. The apparatus generally includes means for determining a first state of a neuron model at or shortly after a first event, wherein the neuron model has a closed-form solution in continuous time; and means for determining a second event when, if ever, a second state of the neuron model will occur, based on the first state, wherein dynamics of the first and second states are coupled to the neuron model only at the first and second events, respectively, and are decoupled between the first and second events.

Certain aspects of the present disclosure provide a computer-program product for neural networks. The computer-program product generally includes a computer-readable medium having instructions executable to determine a first state of a neuron model at or shortly after a first event, wherein the neuron model has a closed-form solution in continuous time; and to determine a second event when, if ever, a second state of the neuron model will occur, based on the first state, wherein dynamics of the first and second states are coupled to the neuron model only at the first and second events, respectively, and are decoupled between the first and second events.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example network of neurons in accordance with certain aspects of the present disclosure.

FIG. 2 is a graph of state for an example neuron model, illustrating a positive regime and a negative regime for defining behavior of the model, in accordance with certain aspects of the present disclosure.

FIG. 3 is a table of parameters for defining behavior of an example neuron model, in accordance with certain aspects of the present disclosure.

FIG. 4 is a table of additional parameters for controlling further behavioral aspects of an example neuron model, in accordance with certain aspects of the present disclosure.

FIG. 5 is a flow diagram of example operations for determining an operating regime for a neuron model, in accordance with certain aspects of the present disclosure.

FIG. 5A illustrates example means capable of performing the operations shown in FIG. 5.

FIG. 6 is a flow diagram of example operations for determining states of a neuron model, in accordance with certain aspects of the present disclosure.

FIG. 6A illustrates example means capable of performing the operations shown in FIG. 6.

FIG. 7 is a flow diagram of example operations for determining an event when a certain state of a neuron model will occur, in accordance with certain aspects of the present disclosure.

FIG. 7A illustrates example means capable of performing the operations shown in FIG. 7.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Neural System

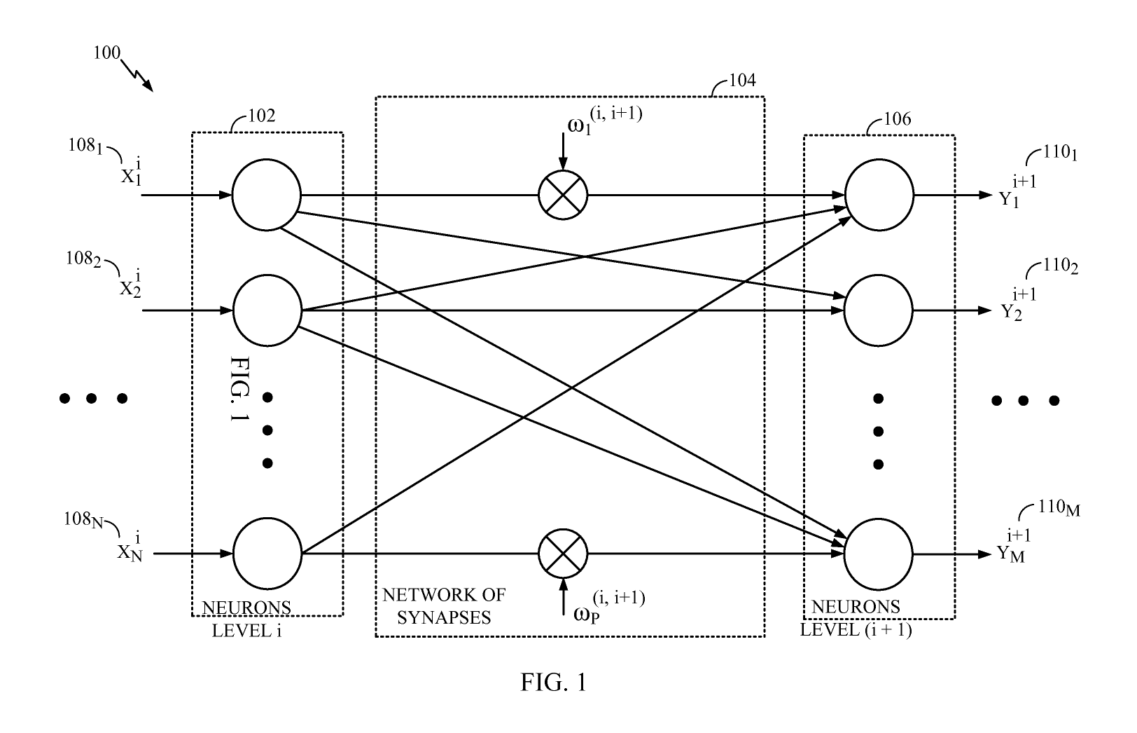

FIG. 1 illustrates an example neural system 100 with multiple levels of neurons in accordance with certain aspects of the present disclosure. The neural system 100 may comprise a level of neurons 102 connected to another level of neurons 106 though a network of synaptic connections 104. For simplicity, only two levels of neurons are illustrated in FIG. 1, although fewer or more levels of neurons may exist in a typical neural system.

As illustrated in FIG. 1, each neuron in the level 102 may receive an input signal 108 that may be generated by a plurality of neurons of a previous level (not shown in FIG. 1). The signal 108 may represent an input (e.g., an input current) to the level 102 neuron. Such inputs may be accumulated on the neuron membrane to charge a membrane potential. When the membrane potential reaches its threshold value, the neuron may fire and generate an output spike to be transferred to the next level of neurons (e.g., the level 106).

The transfer of spikes from one level of neurons to another may be achieved through the network of synaptic connections (or simply “synapses”) 104, as illustrated in FIG. 1. The synapses 104 may receive output signals (i.e., spikes) from the level 102 neurons (pre-synaptic neurons relative to the synapses 104). For certain aspects, these signals may be scaled according to adjustable synaptic weights [symbol] , . . . , [symbol] (where P is a total number of synaptic connections between the neurons of levels 102 and 106). For other aspects, the synapses 104 may not apply any synaptic weights. Further, the (scaled) signals may be combined as an input signal of each neuron in the level 106 (post-synaptic neurons relative to the synapses 104). Every neuron in the level 106 may generate output spikes 110 based on the corresponding combined input signal. The output spikes 110 may be then transferred to another level of neurons using another network of synaptic connections (not shown in FIG. 1).

The neural system 100 may be emulated in software or in hardware (e.g., by an electrical circuit) and utilized in a large range of applications, such as image and pattern recognition, machine learning, motor control, and the like. Each neuron (or neuron model) in the neural system 100 may be implemented as a neuron circuit. The neuron membrane charged to the threshold value initiating the output spike may be implemented, for example, as a capacitor that integrates an electrical current flowing through it.

### Example Dynamical Event-Based Models

Fundamentally important biological neural behaviors may be impossible to emulate or predict with typical spiking neuron models because those models do not capture: (i) fine (continuous) timing or (ii) continuous time dynamics. Even models that are expressed in continuous time differential equation form have no closed-form solution and thus are often approximated by numerical methods, such as iteratively, for example, using the Euler method. The problem with iterative models is evident when observing how spike timing can change dramatically (e.g., by tens of milliseconds or more) merely by changing only the time step resolution, even by only a small amount (e.g., from 1 ms to 0.1 ms). The behavior of such models also typically depends strongly on details of the method of implementation rather than fundamental aspects of the theoretical model. While attempting to approximate such models with fine time steps may also be computationally burdensome, more importantly, it generally fails to account for continuous time dynamics, particularly if the model has multiple inter-dependent state variables (such as voltage and current) and multiple attractors.

Accordingly, what is needed is a continuous time dynamical neuron model that is capable of capturing biologically realistic temporal effects.

### General Principles for a Useful Neuron Model

What makes a good neuron model? The answer may depend on the perspective and purpose. Assuming both neuroscience and engineering objectives, a model that has biologically realistic (or at least biologically consistent behavior) and is computationally attractive may be desired.

The present disclosure sets forth general principles for designing a useful spiking neuron model. A good neuron model has rich potential behavior in terms of two computational regimes: coincidence detection and functional computation. Moreover, a good neuron model should have two elements to allow temporal coding: arrival time of inputs affects output time and coincidence detection can have a narrow time window. Finally, to be computationally attractive a good neuron model should have a closed-form solution in continuous time and have stable behavior including near attractors and saddle points. In other words, a useful neuron model is one that is practical and that can be used to model rich, realistic and biologically-consistent behaviors, as well as be used to both engineer and reverse engineer neural circuits in well-defined, stable computational relations.

Behavior from Events

Natural nerve cells appear to exhibit a plethora of behaviors including tonic and phasic spiking and bursting, integrating input, adapting to input, oscillating sub-threshold, resonating, rebounding, accommodating input, and more. Often different behaviors may be induced by inputs with different characteristics.

For certain aspects of the present disclosure, these cells may be viewed as abstract event state machines in which cell dynamics are determined by events. Furthermore, in this view, events set cell dynamics in motion until the next event, where the dynamics between events are constrained depending on state at the time of the prior event.

To put this in concrete terms, consider three consecutive input events where the first and last events comprise instantaneous inputs that significantly alter the state at their time of occurrence. Assume the middle event has no associated input. Now, consider a hypothetical neuron model in which the behavior changes if the middle event is omitted. With this hypothetical neuron model, the event itself is significant, even if there is no associated input or output. Certain aspects of the present disclosure provide such a neuron model.

The purpose of a neuron model that depends on events themselves is to achieve rich behavioral characteristics with low complexity. To achieve a rich behavioral repertoire, a state machine that can exhibit complex behaviors may be desired. If the occurrence of an event itself, separate from the input contribution (if any) can influence the state machine and constrain dynamics subsequent to the event, then the future state of the system is not only a function of a state and input, but rather a function of a state, event, and input. Events are added dependencies. Given more dependencies, one may potentially simplify individual dependencies (e.g., how future state depends on past state) and yet achieve an equivalent or richer behavioral repertoire.

This principle may be expressed mathematically by defining a univariate or multivariate state S that evolves absent any events between time t₀ and t_{ƒ} according to

S(t_{ƒ})=ƒ(t_{ƒ},S(t₀)) (1.1)

However, upon an event at time t, the state evolves according to

S [symbol] =g [symbol] S [symbol] (1.2)

Effectively, this means if there is one event at time t between times t₀ and t_{ƒ}, the state evolves between time t₀ and t_{ƒ} according to

S(t_{ƒ})=ƒ(t_{ƒ},g(t,S(t₀)) (1.3)

and so on. The significance of this is that there may be dependence on t regardless of input or even whether there is input.

Certain aspects of the present disclosure provide a neuron model with such a property, and other desirable properties, which is described below. But first, the present disclosure provides a discussion of principles behind other desirable properties.

### Temporal Coding

A useful neuron model can perform temporal coding. And if a neuron model can do temporal coding, then it can also perform rate coding (since rate is just a function of timing or inter-spike intervals).

Arrival Time

In a good neuron model, the time of arrival of an input should have an effect on the time of output. A synaptic input—whether a Dirac delta function or a shaped post-synaptic potential (PSP), whether excitatory (EPSP) or inhibitory (IPSP)—has a time of arrival (e.g., the time of the delta function or the start or peak of a step or other input function), which may be referred to as the input time. A neuron output (i.e., a spike) has a time of occurrence (wherever it is measured, e.g., at the soma, at a point along the axon, or at an end of the axon), which may be referred to as the output time. That output time may be the time of the peak of the spike, the start of the spike, or any other time in relation to the output waveform. The overarching principle is that the output time depends on the input time.

One might at first glance think that all neuron models conform to this principle, but this is generally not true. For example, rate-based models do not have this feature. Many spiking models also do not generally conform. A leaky-integrate-and-fire (LIF) model does not fire any faster if there are extra inputs (beyond threshold). Moreover, models that might conform if modeled at very high timing resolution often will not conform when timing resolution is limited, such as to 1 ms steps.

With an ideal neuron model, the output time will change if the time of any input changes. A good model will conform in a well-defined manner most of the time. For example, the Simple Model generally exhibits a spike timing behavior that is dependent on input times. However, the quadratic differential equation causes a fast voltage rise so that the magnitude of an input may have more relevance than the time of an input. An anti-leaky-integrate-and-fire (ALIF) model and certain aspects of the present disclosure have a more well-defined dependence of output time on input time, as described below.

Coincidence

A useful neuron model should be able to detect fine timing coincidences. This may demand that the impact of an input is not unnecessarily spread out in time. A simple integration model spreads out an input to infinite time. A LIF model limits the spread by leaking. The faster the model leaks, the finer the ability of the neuron to detect a timing coincidence. Thus, a model that leaks exponentially has, all other factors being equal, better timing coincidence detection capability than a model that leaks linearly.

An ideal model would have a variable coincidence detection window. However, detection window can be no smaller than the neuron model's best coincidence detection time resolution. For example, in the Simple Model, the rate of leak depends quite dramatically on the membrane potential. Near threshold, the neuron model retains the input effect for a considerable time, while mid-way between rest and threshold, the neuron model loses the input effect more quickly. Unfortunately, this means the Simple Model detection capability is limited by the slow (almost zero) leak rate near the threshold, which degrades coincidence detection capability almost to the point of a purely integrating model. Moreover, the leak depends on the recovery current variable, as well, meaning that the leak can be even worse than flat and can even increase resulting in voltage increasing despite lack of further input. In contrast to the above, to solve these problems, certain aspects of the present disclosure, despite having dependence on multiple state variables, also have fine timing coincidence resolution capability (as do LIF and ALIF models). To be able to vary the coincidence detection window, certain aspects of the present disclosure use input formulations which spread the input over a longer time instead of altering the fine resolution of the neuron model.

### Dual Computational Regimes

A good neuron model has rich behavior possibilities to model different biologically realistic effects. Two potential computational regimes may be important: one of integrative coincidence detection and one of spike-timing functional determination.

Temporal Detection

For coincidence detection, a useful neuron model should have a regime in which it is able to forget history. This allows a neuron to be used as a detector: a spike occurs upon detection (when detection occurs) and no spike occurs if there is no detection. A LIF neuron model or neuron model with LIF-type behavior may suffice. LIF models are able to detect temporal coincidences to a degree depending on the rate of leak (or decay), which determines how fast the neuron forgets about the prior input and how consistently. However, such models may be limited in terms of other computational properties or biological behaviors that may be reproduced.

What is desired is that the rate of leak be high enough to lose memory of prior inputs that are outside the window of computational relevance (relative frame). While considering more advanced models, one should strive to retain the advantages of this leaky-integrate-and-fire behavior and not obviate these advantages by designing models that prevent, complicate or destabilize such temporal coincidence detection capabilities. Models such as the Simple Model have degraded the leak. In the case of the Simple Model, there is almost no leak near the voltage threshold as discussed above. In contrast, certain aspects of the present disclosure have these desirable LIF-type behaviors.

Temporal Computation

Spiking neuron models are often defined in terms of a threshold. When the threshold is exceeded, the model spikes. Rather than contemplating whether there is such a threshold in biological cells, certain aspects of the present disclosure consider whether there is an invoking event after which a cell will fire, such that it is only a matter of time before firing.

Certain aspects of the present disclosure consider a model with such well-defined properties where the latency is variable. If a cell would fire with a particular fixed latency, the usefulness of the property might be limited since a delay can be achieved by axonal, synapse, or dendritic processes. But if the relative delay between an invoking event and a spike was variable depending on inputs or events subsequent to the invoking event, then one would effectively have a computational engine that generates an output coded in the relative delay, which is potentially a function of relative delays from the invoking events and interim events (including inputs). This would be a function that gives a relative output time as a function of relative input times (whether sub-threshold or super-threshold). This would indeed be useful, particularly if the function was well defined, because it would not only provide a framework for engineering a system with spiking neurons, but also a framework for understanding what a network of spiking neurons is computing.

Returning to the question of whether such a behavior might exist in biological cells, such cells have regenerative upstroke dynamics generating what is referred to as the voltage spike. The often overlooked A-channel is a voltage-gated transient potassium ion channel that activates quickly, which can counteract rapid sodium influx and slow the regenerative upstroke. As a result, it is possible to achieve very long latencies (hundreds of milliseconds or longer) from the time the upstroke is invoked until the spike peak occurs. The voltage level to trigger the A-channel may be slightly below the “threshold” for the sodium channel chain reaction, so the actual timing of events and input may alter the latency properties, as well.

For functional computation, a good neuron model should have a regime in which it will fire regardless of further input, it is only a matter of when it will fire. This regime allows a neuron to be used as a computational device in which the interval between spikes can code information. This is different from detection because it is the time of the spike that codes information, not the existence of the spike itself. The ALIF model and certain aspects of the present disclosure exhibit this behavior. The Simple Model possesses a similar behavior, although the Simple Model cannot be represented in closed form and the quadratic nature of the voltage rise can diminish dependence of output time on input times because it is less discriminating to input time differences as opposed to input magnitude differences. The nature of the Simple Model dynamical equations means the voltage can stay relatively steady near the threshold (on either side). This means that a small difference in magnitudes of inputs can actually have a diverging effect on voltage traces: the difference between voltage traces with and without a magnitude difference increases before converging. This creates instability when learning because, in learning, weights are being adjusted by small amounts, but the effect on the voltage trace is magnified at a time shortly following input effects. In contrast, with certain aspects of the present disclosure (as well as LIF and ALIF models) the effect of a magnitude change in input results in converging voltage state trace.

### Continuous Time Modeling

A good model should be computationally convenient, being stable and directly computable.

Closed Form

Many biologically motivated neuron models are described by differential equations. For example, the Simple Model is described by two second-order differential equations. Unfortunately, these equations cannot be solved in closed form. With a good neuron model, one should be able to directly compute when the neuron will fire (if ever) based on the inputs and current state. Since this cannot be done with the Simple Model (without a lookup table, which has limited resolution), the Euler method of step-based integration is typically used. However, this is computationally burdensome at high timing resolution, as well as unstable at low timing resolution. Moreover, such models suffer in terms of behavior because the behavior may depend more on implementation details (e.g., order of state propagation, numerical method details, and time resolution) than fundamental aspects of the theoretical dynamical equations (as opposed to the actual dynamics).

The LIF, ALIF, and certain aspects of the present disclosure can be solved directly. However, only the ALIF and certain aspects of the present disclosure have non-zero delay until spiking once sufficient input has arrived.

Stability

From a biological modeling perspective, a neuron model is desired for which one can easily determine parameters to match a biological cell's behavior over a broad range of conditions. A problematic model would change behavior for one regime away from biologically desired behavior every time one tries to configure the behavior to match a second regime. Or, the behavior would change dramatically with a small parameter change.

In contrast with these problematic models, an ideal model should be stable in implementation. This is most often a problem near saddle points or attractors. Also, when models are solved by integration (e.g., Euler), the assumption that first derivatives of state variables do not change over the time step is often a poor approximation near thresholds and large values. As a result, computations can typically overshoot or undershoot in step-wise determinations. Models that have a closed-form solution (such as ALIF and certain aspects of the present disclosure) thus have an advantage for stability in implementation.

From an engineering standpoint, a neuron model is desired that has stable computational properties including temporal detection and temporal computation.

### Example Neuron Model

Certain aspects of the present disclosure provide a behaviorally rich, biologically-consistent, computationally-convenient model of a neuron which adheres to the principles described above. In this section, a model designed to achieve this is presented. The general model is unique in that it is defined by the state at the time of events and by operations governing the change in that state from one event to the next event.

### Model Definition

The model is defined in terms of events, and events are fundamental to the defined behavior. The behavior depends on events, the inputs and outputs occur upon events, and the dynamics are coupled at events.

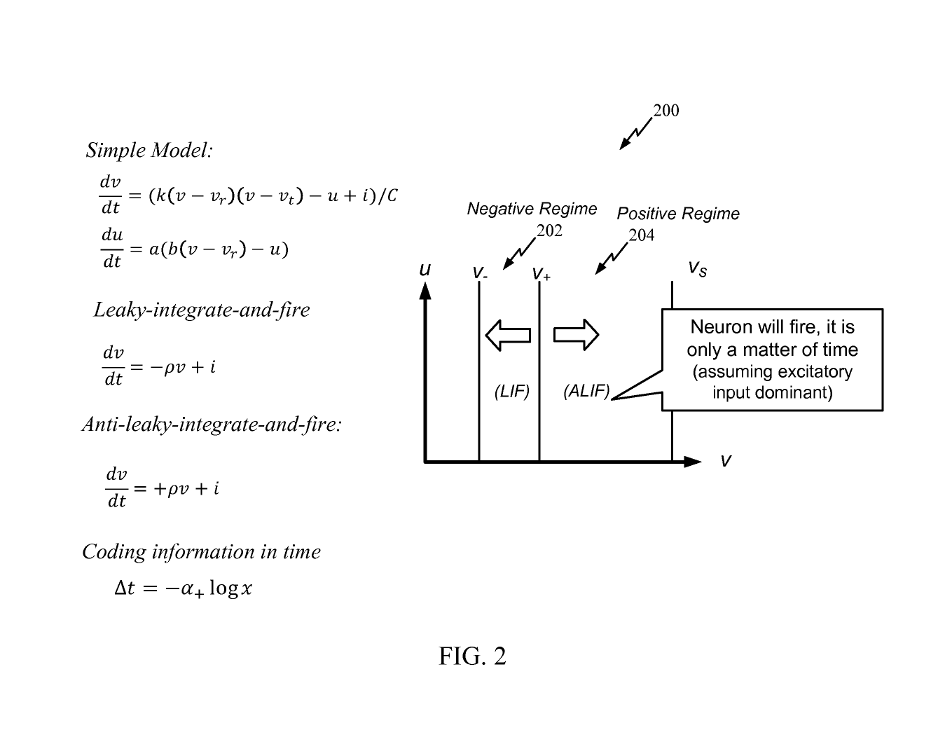

As illustrated in the graph 200 of recovery current versus membrane potential (voltage) in FIG. 2, the dynamics of the model may be divided into two (or more) regimes. These regimes may be called the negative regime 202 (also interchangeably referred to as the LIF regime, not to be confused with the LIF neuron model) and the positive regime 204 (also interchangeably referred to as the ALIF regime, not to be confused with the ALIF neuron model). In the negative regime 202, the state tends toward rest (ν₋) at the time of a future event. In this negative regime the model generally exhibits temporal input detection properties and other sub-threshold behavior. In the positive regime 204, the state tends toward a spiking event (νₛ). In this positive regime, the model exhibits computational properties, such as incurring a latency to spike depending on subsequent input events. Formulation of dynamics in terms of events and separation of the dynamics into these two regimes are fundamental characteristics of the model.

The symbol ρ is used herein to denote the dynamics regime with the convention to replace the symbol ρ with the sign “−” or “+” for the negative and positive regimes, respectively, when discussing or expressing a relation for a specific regime.

The model state is defined by a membrane potential (voltage) ν and recovery current u. In basic form, the regime is essentially determined by this state. There are subtle, but important aspects of the precise and general definition, but for the moment, consider the model to be in the positive regime 204 if the voltage ν is above a threshold (ν₊) and otherwise in the negative regime 202. This will suffice for understanding the basic model dynamics definitions in individual regimes as explained below, while a precise and complete definition of determining regime is provided below.

The dynamics of the model state are conveniently described in terms of dynamics of a transformed state pair (ν′,u′) The state transformations at event time are

ν′=ν+q_{ρ} (2.1)

u′=u+r (2.2)

where q_{c} and r are the linear transformation variables. The voltage transformation depends on the regime ρ. The model dynamics, which are also dependent on the regime, are defined by differential equations in terms of the transformed state pair

$$\begin{matrix}{τ}_{ρ} \frac{d {v}^{′}}{d t} = {v}^{′} & ( 2.3 ) \\ {τ}_{u} \frac{d {u}^{′}}{d t} = - {u}^{′} & ( 2.4 )\end{matrix}$$

where τ₋ is the negative regime time constant, τ₊ is the positive regime time constant, and τᵤ is the recovery time constant. For the moment, let us assume these are constant values, although variable time constants are described below. For convenience, the negative regime time constant τ₋ will be specified as a negative quantity to reflect decay so that the same expression for voltage evolution may be used as for the positive regime in which the exponent and τ₊ will generally be positive, as will be τᵤ.

The state dynamics of the model may be defined in an event framework. Between events, the dynamics may be defined by ordinary differential equations (ODEs). The dynamics of the two state elements may generally be coupled at events by transformations offsetting the states from their null-clines at the time of the event, where the transformation variables are

q_{ρ}=−τ_{ρ}βu−ν_{ρ} (2.5)

r=δ(ν+ε) (2.6)

where δ, ε, β, and ν₋, ν₊ are parameters. The two values for ν_{ρ} are the base or reference voltages for the two regimes. The parameter ν₋ is the base voltage for the negative regime, and the membrane potential will generally decay toward ν₋ in the negative regime. The parameter ν₊ is the base voltage for the positive regime, and the membrane potential will generally tend away from ν₊ in the positive regime.

The null-clines for ν and u are given by the negative of the transformation variables q_{ρ} and r, respectively. The parameter δ is a scale factor controlling the slope of the u null-cline. The parameter ε is typically set equal to −ν₋. The parameter β is a resistance value controlling the slope of the ν null-clines in both regimes. The τ_{ρ} time-constant parameters control not only the exponential decays, but also the null-cline slopes in each regime separately.

The model is defined to spike when the voltage ν reaches a value νᵣ. Subsequently, the state is typically reset at a reset event (which technically may be one and the same as the spike event):

ν=\hat{ν}₋ (2.7)

u=u+Δu (2.8)

where \hat{ν}₋ and Δu are parameters. The reset voltage \hat{ν}₋ is typically set to ν₋.

The model has closed-form solutions for state evolution at time t+Δt given the state {ν′,u′} at time t:

$$\begin{matrix}{v}^{′} ( t + Δ t ) = {v}^{′} ( t ) {e}^{\frac{Δ t}{{τ}_{ρ}}} & ( 2.9 ) \\ {u}^{′} ( t + Δ t ) = {u}^{′} ( t ) {e}^{- \frac{Δ t}{{τ}_{u}}} & ( 2.10 )\end{matrix}$$

Therefore, the model state may most likely be, and is defined to be, updated only upon events such as upon an input (pre-synaptic spike) or output (post-synaptic spike). This is generalizable because operations may also be performed on artificial events (whether or not there is input or output) which are described below. By definition, transformations are defined at events, not between events. This means that q_{ρ} and r and even ρ need not be recomputed unless there is an event.

This definition means that the model may only be coupled at events, and the regime (whether positive or negative) may only be determined at events. The model state variables ν and u are generally coupled as described above via variables q_{ρ} and r which are only determined at events (or steps). The variables q_{ρ} and r may be computed based on the prior state. The state elements may then be evolved independently to the next state. In effect, this means the state variables are “momentarily decoupled” between events.

Moreover, the time of a post-synaptic spike may be anticipated so the time to reach a particular state may be determined in advance without numerical methods. Given a prior voltage state ν₀, the time delay until voltage state ν_{ƒ} is reached is given by

$$Δ t = {τ}_{ρ} log \frac{{v}_{f} + {q}_{ρ}}{{v}_{0} + {q}_{ρ}} \qquad ( 2.11 )$$

If a spike is defined as occurring at the time the voltage state ν reaches νₛ, then the closed-form solution for the amount of time, or relative delay, until a spike occurs as measured from the time that the voltage is at a given state ν is

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \} \qquad ( 2.12 )$$

where \hat{ν}₊ is typically set to parameter ν₊, although other variations and their motivations are described below.

The above definitions of the model dynamics depend on whether the model is in the positive or negative regime. As mentioned, the coupling and the regime ρ may be computed upon events. For purposes of state propagation, the regime and coupling (transformation) variables may be defined based on the state at the time of the last (prior) event. For purposes of subsequently anticipating spike output time, the regime and coupling variable may be defined based on the state at the time of the next (current) event.

For determining regime, the basic form is that if ν>\hat{ν}₊ then the model is in the positive regime and otherwise in the negative regime. Typically, \hat{ν}₊ is a constant set to equal ν₊, but it may also be set separately or be variable.

According to certain aspects of the present disclosure, input may only be applied to the model at events. In a typical formulation, input may be applied to the model state after the state has been advanced from a prior event to the time of an input event. Thus, more generally

$$\begin{matrix}{v}^{′} ( t + Δ t ) = {h}_{v} ( {v}^{′} ( t ) {e}^{\frac{Δ t}{{τ}_{ρ}}} , i ) & ( 2.13 ) \\ {u}^{′} ( t + Δ t ) = {h}_{u} ( {u}^{′} ( t ) {e}^{- \frac{Δ t}{{τ}_{u}}} , i ) & ( 2.14 )\end{matrix}$$

where h_{ν} and hᵤ are called input channel functions. In a simple case, instantaneous current inputs may be modeled as discrete Dirac delta functions, i.e., i=θ(t), applied to voltage state. In this case, input to the model state applies at the time of the event and

h_{ν}(x,i)=x+iβ;hᵤ(x,i)=x (2.15)

where β is the membrane resistance.

However, inputs may alternatively be continuous, such as a sum of weighted exponential decays describing an excitatory or inhibitory post-synaptic potential, whether current- or conductance-based. In this case, input to the model state may be applied at the time of the event, but also potentially before or after the event. Thus, the equivalent total integrated input contribution, from the input for the next event and inputs from past events, as accumulated between a prior event and a next event may be applied at the time of the next event. Thus, closed-form solutions for continuous input contributions are also an advantage.

A continuous exponentially decaying excitatory or inhibitory input may be defined by

$${τ}_{g} \frac{d g}{d t} = - g \qquad ( 2.16 )$$

which has a closed-form solution and thus may be evolved from event to event decoupled from the {ν,u} state. The total contribution over a time period from a prior event at time t to a next event at time t+Δt is given by

$$i = {\int }_{t}^{t + Δ t} g d t = g {τ}_{g} ( 1 - {e}^{- \frac{Δ t}{{τ}_{g}}} ) \qquad ( 2.17 )$$

where g<0 for an inhibitory contribution, g<0 for an excitatory contribution, and the same input channel functions may be used as for Dirac inputs.

Conductance-based input may also be integrated as follows:

$$i = {\int }_{t}^{t + Δ t} ( v - {E}_{g} ) g d t = ( v - {E}_{g} ) g {τ}_{g} ( 1 - {e}^{- \frac{Δ t}{{τ}_{g}}} ) \qquad ( 2.18 )$$

where E_{g} is the reference voltage for the input and V is a voltage level computed to compensate for removing the (ν−E_{g}) term from the integral. The approximation V=ν(t) (the voltage at the prior event) holds well if ν changes by a relatively small amount across events or events occur at small inter-event-intervals. If not, more sophisticated formulations of V or use of artificial events, described below, can be used to achieve desired effects while keeping with the definition of the model.

According to certain aspects of the present disclosure, the anticipation of spike output does not account for future input between events. The general reason for this is computational simplicity and independence. And, even though closed-form solutions may be available for some continuous input formulations, the equivalent effects can be achieved if the rate of events is sufficiently high, by alternatively defining input or channel functions and, otherwise by using artificial events, as described below.

According to certain aspects of the present disclosure, plasticity applies at events. Spike-timing-dependent plasticity (STDP) is particularly suited to this because long-term potentiation (LTP) and long-term depression (LTD) can be viewed as triggered by a pre-synaptic (input) event preceding or following a post-synaptic (output) event, respectively. Structural or temporal plasticity would also apply at events. Structural plasticity may be thought of as modifying, creating, or deleting synaptic connections, for example. Equivalently, the parameters of an abstract synapse, such as delay and weight, may be changed as if the abstract synapse used to model a deleted synapse was reused to model a new synapse with different parameters. Thus, one may generalize multiple forms of plasticity in terms of variable synaptic parameters. The variability may be at discrete moments or continuous, but regardless are evolved in the model from event to event.

### Algorithmic Solution

The algorithmic solution to the model comprises: (i) advancing the state from a prior event to a next event; (ii) updating the state at the next event time given the input at the next event time (or applying, at the time of the next event, an input equivalent to that accumulated between the prior and next events); and (iii) anticipating when the next event will occur. Events include input events, which are typically considered to occur at the time a synaptic input propagates to the neuron's soma. Events also include output events, which are typically considered to occur at the time a spike is emitted by the neuron's soma and begins propagating along the axon. Since closed-form solutions are available, the model state may also be determined between events if so desired, but regime and coupling need not be updated unless there is an event.

In a typical formulation, input may be applied to the model state after the state has been advanced from a prior event to the time of an input event. Inputs may be modeled as discrete Dirac delta functions. In this case, input to the model state applies at the time of the event. However, inputs may also be continuous, such as a sum of weighted exponential decays describing an excitatory or inhibitory post-synaptic potential, whether current- or conductance-based. In this case, input to the model state applies at the time of the event, but also potentially before or after the event. Therefore, the equivalent total integrated input contribution, from the input for the next event and inputs from past events, as accumulated between a prior event and a next event may be applied at the time of the next event. Thus, closed-form solutions for continuous input contributions are also an advantage. The following algorithm describes the operations typically conducted upon an input event:
1. Determine the time Δt since the prior event given the prior event time t.
2. Determine the regime based on the prior state {ν,u} at the prior event.
3. Determine the transformation variables q_{ρ} and r given the prior state at time t.
4. Determine the transformed state {ν′,u′} given the prior state {ν,u} at time t.
5. Determine the advanced transformed state at time t+Δt.
6. Determine the advanced state {ν,u} at time t+Δt.
7. Determine the advanced input state and incorporate new input to obtain an equivalent inter-event interval integrated input contribution.
8. Determine the new state {ν,u} by applying the equivalent input.
9. Determine the updated transformation variable q_{ρ}.
10. Anticipate the relative delay Δtₛ until the next output spike event.

In a typical formulation, an output event comprises no input. The following algorithm describes the operations typically conducted upon an output event::
1. Reset the state {ν,u}.
2. Determine the updated transformation variable q_{ρ}.
3. Anticipate the relative delay Δtₛ until the next output spike event.

Both input and output event operations described above include anticipating when the next output spike will occur. This is because state updates may change the anticipated time of the spike.

### Artificial Events

By definition the model is updated only upon events. But an artificial event may be defined and utilized for certain aspects. An artificial event is an event defined for purposes of defining model dynamics behavior. There are several reasons why a modeler may wish to define artificial events.

However, let us first dispel a potential misconception. Modelers often wish to see traces of voltage and current state at a fine time resolution. Those states can be computed periodically between events without defining artificial events. This would entail computing the voltage and current using the transformation variables and regime as computed at the prior event (not the prior period). Transformation variables and regime may only be computed at events. This subtle point is important because the model's behavior depends on the timing of events.

By definition, the coupling transformations are defined at events, not between events. This means that q_{ρ} and τ and even ρ may most likely not be recomputed unless there is an event. So, assuming no artificial events have been defined, the voltage and current state may be updated between events if so desired, but based on the parameters and offsets from the prior event. In other words, by definition, coupling may most likely occur only at events.

Basically, defining artificial events allows a modeler to alter the coupling. There may also be reasons for defining artificial events at convenient times. There is no wrong way to define or not define artificial events, but the modeler should understand that defining artificial events generally changes the behavior of the model.

One reason to define an artificial event is to achieve a behavior characteristic of a model instance with a high rate of events using a model instance with a lower rate of events. If there is a high rate of input events, the model dynamics are advanced at small time intervals. However, if there is a low rate of input events, the model dynamics, without artificial events, may be advanced by larger time intervals. Generally, the difference in behavior may not be significant unless the time intervals are much larger. Even then, adjustments to parameters such as the time constants may be made to compensate.

However, alternatively or if desired, artificial events may be defined. In particular, artificial events may be defined to occur between non-artificial events if the interval between the non-artificial events is large. Technically, this may be achieved in several ways. For example, an artificial event may be tentatively scheduled with some delay after each non-artificial event. If another non-artificial event occurs before the artificial event, then the artificial event may be rescheduled to some delay after the latest non-artificial event. If the artificial event does occur first, then it may be rescheduled again with the same delay. Another way is to schedule artificial events periodically. Artificial events may also be defined to occur conditionally, such as dependent on state or spiking rate.

Generally, the model is suited to solutions in event-based simulation as described above. However, the model may also be solved in conventional step-based simulations. But there are fundamentally two ways to do this: (i) without artificial events; and (ii) with artificial events. These are, by definition, different instances of the model. The model operations are defined to occur at events (whether artificial or other). Thus, without artificial events, the code executing at each step may most likely be conditioned on the occurrence of an event at that time slot (effectively, no operation may occur at steps where there is no event). Alternatively, with artificial events, an artificial event may be defined to occur at every time slot. Since the closed-form solutions are available, there is no need for numerical methods regardless of whether the time between events is constant or variable.

While periodic artificial events would generally entail more computations and would therefore be less desirable, there are some potential simplifications: (i) the time Δt since the prior event may be a constant (the time interval); and (ii) spike anticipation may be replaced by checking if ν≧\hat{ν}ₛ at each interval.

First, since the time Δt since the prior event is typically constant, the transformed state update may be simplified to a single multiplication for each state element. The infinite impulse response filters are given by

ν′(t+Δt)=c_{ρ}ν′(t) (2.19)

u′(t+Δt)=cᵤu′(t) (2.20)

where constants c_{ρ}=e^{Δt/τ}^{_{ρ}} and cᵤ=e^{-Δt/τ}^{ᵤ}.

Second, the spiking condition was defined to be ν≧νₛ. However, if the artificial events are defined to occur at a quantized time interval Δt, the spiking condition may actually be reached between intervals. As a result, care should be taken to ensure that the spike occurs at the desired time, whether at the event before or at the event after.

### Fundamental Behavior Control

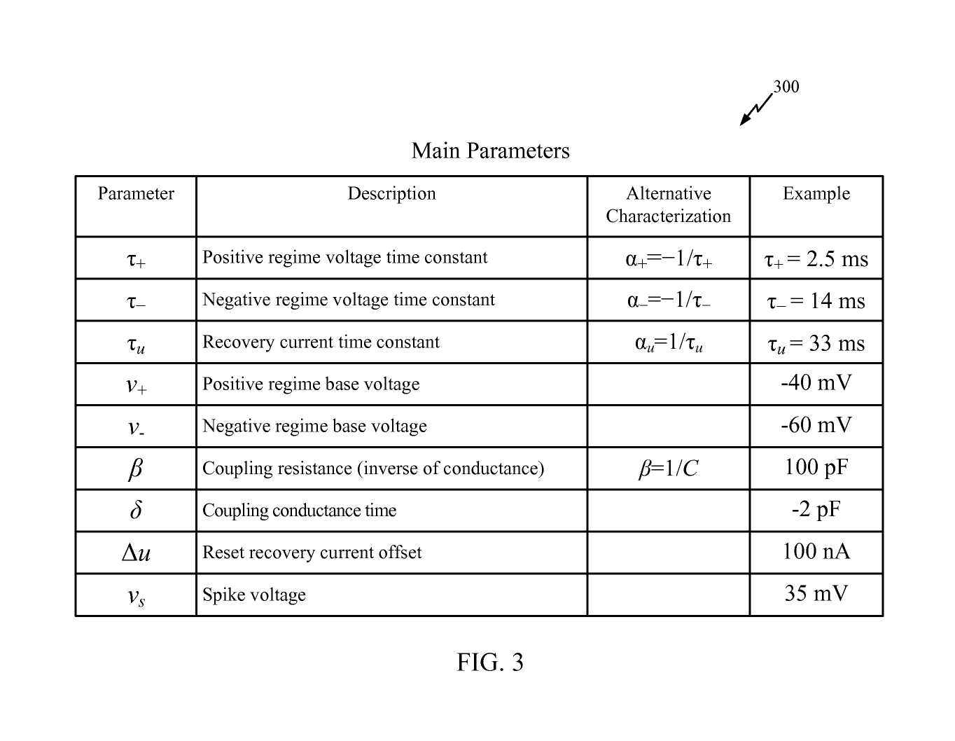

The fundamental model behavior is defined by the parameters illustrated in table 300 of FIG. 3. The time constants (τ₊, τ₋, and τᵤ) control the rate of decay of the voltage or current toward or away from the null-clines which intersect the current axis at the base voltage (ν₊ or ν₋) of the particular regime. Coupling at events is determined by the slope of the transformation equations. For the voltage transformation, the slope is given by τ₊ and β, whereas for the current transformation, the slope is given by δ. This means that the slope of the null-cline in the positive regime border is dependent on the positive regime time constant, but this may be compensated for with β.

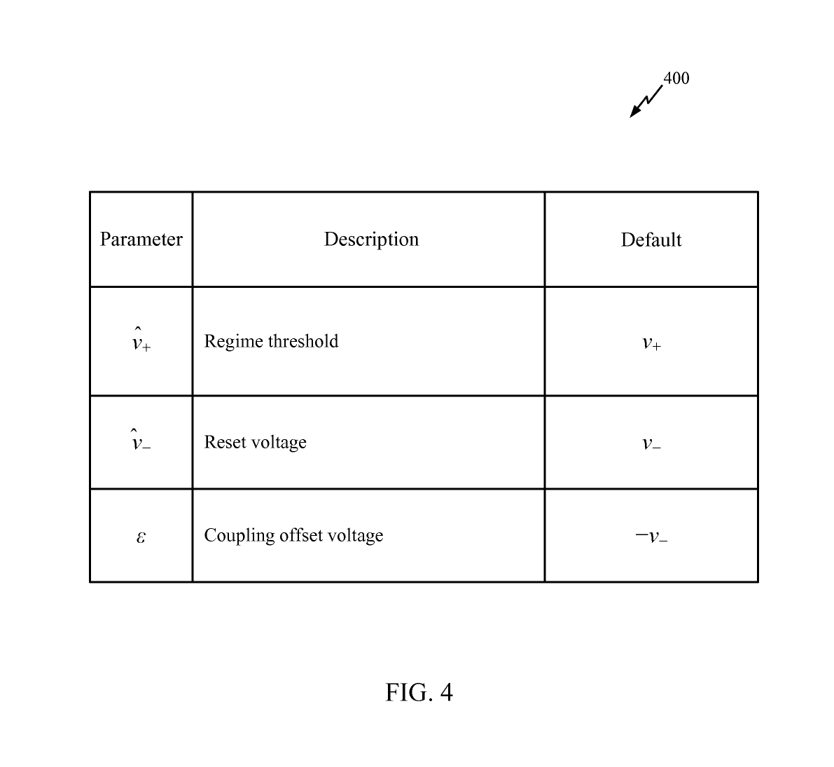

Additional behavioral aspects may be achieved with separate control of the parameters illustrated in table 400 of FIG. 4. Typically, however, the default values shown in table 400 may be used based on the parameters in table 300 of FIG. 3.

The typical setting for the regime threshold given above was \hat{ν}₊=ν₊. However, the voltage null-cline is not a vertical line in the {ν,u} state-space. This characteristic may be advantageous because it allows for richer behaviors. Also, alternatively, the regime threshold may be defined to be the null-cline bordering the positive regime. There are yet other alternatives that may be considered, which are beyond the scope of this disclosure.

Given the state transformations, the null-clines are defined by ν=−q_{ρ} and u=−r.

ν=τ_{ρ}βu+ν_{ρ} or u=(ν−ν_{ρ})/τ_{ρ}β (2.21)

u=−δ(ν+ε)or ν=−u/δ−ε (2.22)

These transformations control the temporal behavior of the model. The voltage transformation offset variable q_{ρ} is a linear equation dependent on the recovery current. When the current is zero, the transformation is entirely due to offset ν_{ρ}. Effectively what this does is shift the voltage state in the transformed state so that the base voltage state is 0. Revisiting the formula for anticipating the spike time, one can see that the logarithm term at u=0 is

$$x = \frac{v - {v}_{ρ}}{{v}_{s} - {v}_{ρ}} \qquad ( 2.23 )$$

Thus, the transformation to state x shifts and normalizes the state model to yield a time delay between 0 and 1 in the positive regime. The information in a spike is in terms of its relative timing. From an information theoretic point of view, one can think of time coding information value (or state) x having range [0,1] as

Δt=−α log x (2.24)

such that the larger the value, the shorter the time delay (response) and a value of 0 corresponds to infinite delay (never spike). Thus, the parameterization of the model allows control of the information representation in spike timing. This aspect is particularly advantageous for computational design purposes.

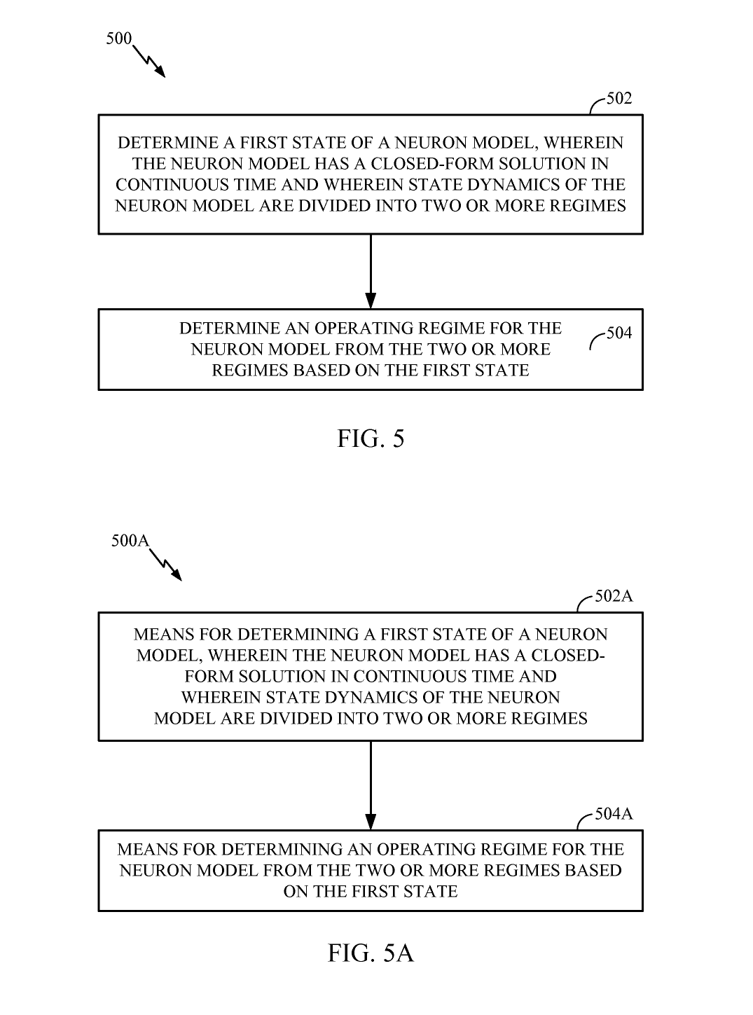

FIG. 5 is a flow diagram of example operations 500 for determining an operating regime for a neuron model, in accordance with certain aspects of the present disclosure. The operations 500 may be performed in hardware (e.g., by one or more processing units), in software, or in firmware.

The operations 500 may begin, at 502, by determining a first state of a neuron model. The neuron model has a closed-form solution in continuous time. Furthermore, state dynamics of the neuron model are divided into two or more regimes. For certain aspects, the neuron model has a variable coincidence detection window. For certain aspects, the first state may be determined after a predetermined period if the neuron model does not receive any event during this period.

At 504, an operating regime for the neuron model may be determined (e.g., selected) from the two or more regimes. This determination of the operating regime may be based on the first state. For certain aspects, the operating regime may be determined at or shortly after a time of an event.

According to certain aspects, the two or more regimes comprise first and second regimes. The state dynamics of the neuron model tend toward rest in the first regime and tend toward spiking in the second regime. For other aspects, the state dynamics of the neuron model tends toward a first reference in a first regime and tend away from a second reference in a second regime. The first or the second reference may include at least one of a point, a line, or a plane. For other aspects, the state dynamics of the neuron model exhibit leaky-integrate-and-fire (LIF) behavior in the first regime and exhibit anti-leaky-integrate-and-fire (ALIF) behavior in the second regime. For other aspects, the neuron model begins losing memory of a prior input after receiving the prior input in the first regime. In the second regime, the neuron model will fire, even with no further excitatory input, such that further excitatory or inhibitory input affects only when the neuron model will fire.

According to certain aspects, the operations 500 may further include determining a second state of the neuron model at a different time than that of the first state. The second state may be determined based on at least one of the first state and the operating regime. For certain aspects, the first state of the neuron model corresponds to a first event, the second state may correspond to a second event, and the second event may be the next event after the first event. In this case, the second state may be determined based on a time between the first event and the second event and on the state dynamics in the operating regime. For certain aspects, the first state is defined by a membrane potential (ν) and a recovery current (u) of the neuron model. In this case, determining the second state includes using the following equations:

$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$

$$r = δ ( v + ɛ )$$

where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, ν_{ρ} is a base voltage for the operating regime, q_{ρ} and r are state transformation variables, δ is a scale factor, and ε is an offset voltage. Algorithmically, the equations may be computed as follows for certain aspects (although variations are also possible with the scope of the present disclosure): (1) the transformation variables q and r are computed; (2) the transformed state ν′ and u′ are computed; (3) the state evolutions are computed; (4) the states are transformed back to ν and u using the q_{ρ} and r variables determined in the first step. Variations may include updating the transformation variables before the fourth step, updating the transformation for one state after the evolution of the other state, etc.

For certain aspects, the first state is a current state of the neuron model, and the second state is a future state after the current state or a prior state before the current state. For other aspects, the first state is a prior state of the neuron model, and the second state is a current state or a future state, after the prior state. For certain aspects, the first or the second event is an input event, an output event, or an artificial event for the neuron model.

According to certain aspects, the operations 500 may further include determining when the neuron model will fire based on at least one of the first state and the operating regime. For certain aspects, the first state is defined by a membrane potential (ν) and a recovery current (u) of the neuron model. Therefore, determining when the neuron model will fire may include using the following rule:

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$

where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire. For other aspects, determining when the neuron model will fire includes using the state dynamics of the neuron model, decoupled from any events. For certain aspects, the operations 500 may further include outputting a spike at an output time according to the determination of when the neuron model will fire.

According to certain aspects, the operations 500 may further include determining, at or shortly after a time of an event, state transformation variables. At least one of the state transformation variables may be dependent on the operating regime. For certain aspects, the operations 500 may further include determining a second state of the neuron model at a different time than that of the first state. This determination of the second state may be based on the first state and the state transformation variables. For certain aspects, the state dynamics of the neuron model may be expressed as ordinary differential equations (ODEs) based on the state transformation variables between events.

According to certain aspects, the operations 500 may further include outputting the first state of the neuron model to a display. For certain aspects, the state dynamics may be defined by a membrane potential and a recovery current of the neuron model.

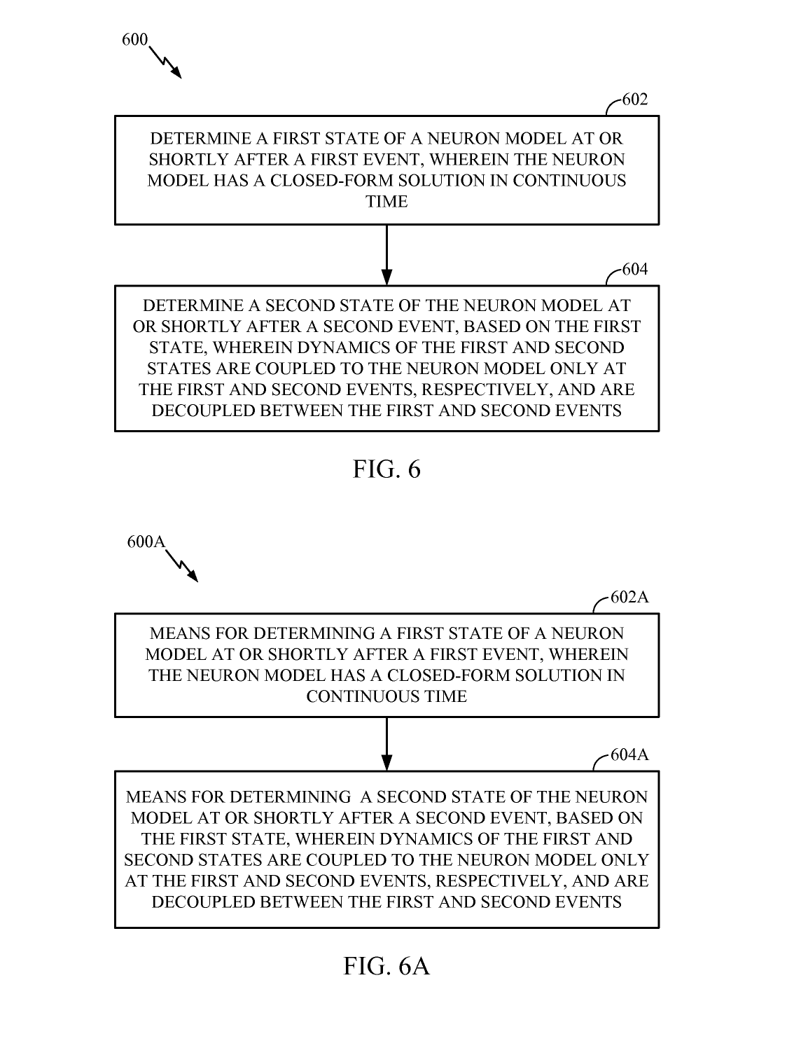

FIG. 6 is a flow diagram of example operations for determining states of a neuron model, in accordance with certain aspects of the present disclosure. The operations 600 may be performed in hardware (e.g., by one or more processing units), in software, or in firmware.

The operations 600 may begin, at 602, by determining a first state of a neuron model at or shortly after a first event. The neuron model may have a closed-form solution in continuous time. For certain aspects, the neuron model has a variable coincidence detection window.

At 604, a second state of the neuron model, at or shortly after a second event, may be determined. This determination may be based on the first state. Furthermore, dynamics of the first and second states may be coupled to the neuron model only at the first and second events, respectively, and may be decoupled between the first and second events.

According to certain aspects, the first and second states are multivariate. The second event may be an input event, an output event, or an artificial event. For certain aspects, the first or the second state is defined by two or more state variables whose dynamics are decoupled between the events and coupled at the events through transformations. For certain aspects, the second event is the next event after the first event.

For certain aspects, the first state is a current state of the neuron model, and the second state is a future state after the current state or a prior state before the current state. For other aspects, the first state is a prior state of the neuron model, and the second state is a current state or a future state, after the prior state.

According to certain aspects, the first state is defined by a membrane potential (ν) and a recovery current (u) of the neuron model. In this case, the second state may be determined using the following equations:

$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$

$$r = δ ( v + ɛ )$$

where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, ν_{ρ} is a base voltage for the operating regime, q_{ρ} and r are state transformation variables, δ is a scale factor, and ε is an offset voltage.

According to certain aspects, the operations 600 may further include determining when the neuron model will fire. This determination may be based on at least one of the first state or the second state. For certain aspects, at least one of the first state or the second state is defined by a membrane potential (ν) and a recovery current (u) of the neuron model. In this case, determining when the neuron model will fire may include using the following rule:

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$

where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire. For other aspects, determining when the neuron model will fire may include using the dynamics of the first and second states. For certain aspects, the operations 600 may further include outputting a spike at an output time according to the determination of when the neuron model will fire.

According to certain aspects, at least one of the first state or the second state may be determined after a predetermined period if the neuron model does not receive any event during this period. For certain aspects, the dynamics of the first and second states may be expressed as ODEs based on state transformation variables between events. According to certain aspects, the operations 600 may further include outputting at least one of the first state, the second state, a first indication of the first event, or a second indication of the second event to a display.

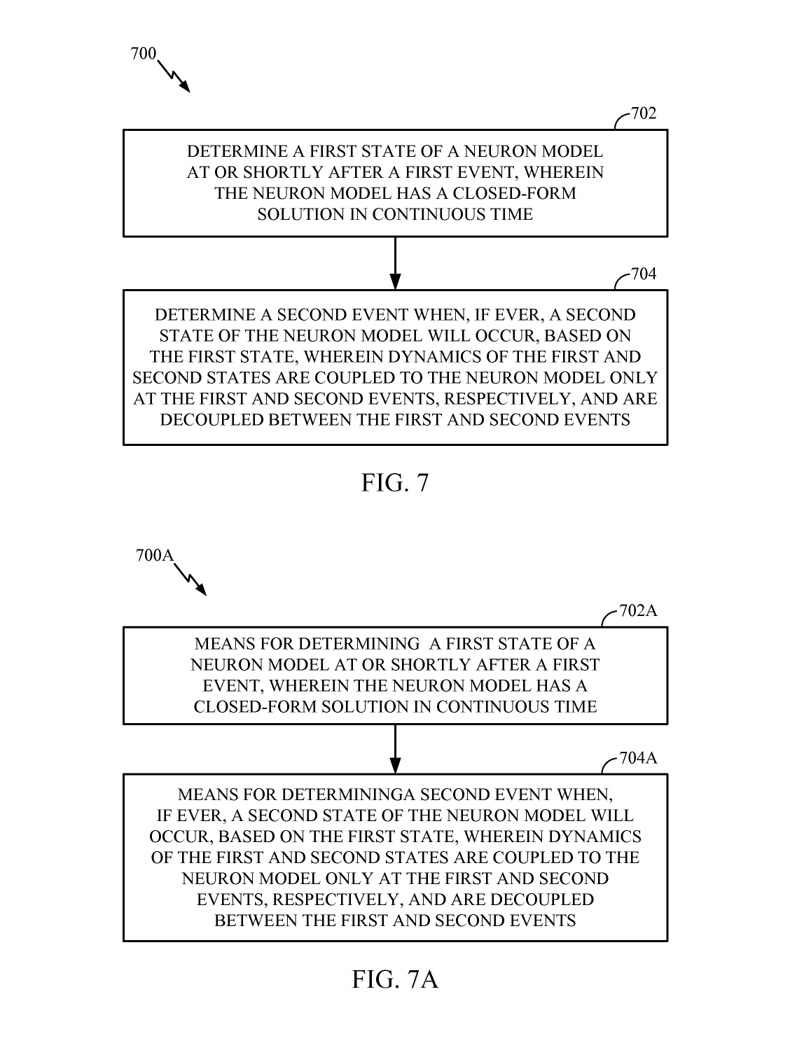

FIG. 7 is a flow diagram of example operations for determining an event when a certain state of a neuron model will occur, in accordance with certain aspects of the present disclosure. The operations 700 may be performed in hardware (e.g., by one or more processing units), in software, or in firmware.

The operations 700 may begin, at 702, by determining a first state of a neuron model at or shortly after a first event. The neuron model may have a closed-form solution in continuous time. For certain aspects, the neuron model has a variable coincidence detection window. For certain aspects, the first state may be determined after a predetermined period if the neuron model does not receive any event during the period.

At 704, a second event when, if ever, a second state of the neuron model will occur may be determined. This determination may be based on the first state. Dynamics of the first and second states may be coupled to the neuron model only at the first and second events, respectively, and may be decoupled between the first and second events. For certain aspects, the dynamics of the first and second states are expressed as ODEs based on state transformation variables between the first and second events

According to certain aspects, the operations 700 may further include outputting a spike at an output time according to the determination of the second event. For certain aspects, the second event is an input event, an output event, or an artificial event. The second event may be the next event after the first event. For certain aspects, the first state is a current state of the neuron model, and the second state is a future state after the current state or a prior state before the current state. For other aspects, the first state is a prior state of the neuron model, and the second state is a current state or a future state, after the prior state.

According to certain aspects, the first and second states are multivariate. For example, the first state may be defined by a membrane potential (ν) and a recovery current (u) of the neuron model. In this case, the second event may be determined using the following rule:

$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$

where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

According to certain aspects, the operations 700 may further include outputting at least one of the first state, the second state, a first indication of the first event, or a second indication of the second event to a display.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 600 illustrated in FIG. 6 correspond to means 600A illustrated in FIG. 6A.

For example, means for displaying may comprise a display (e.g., a monitor, flat screen, touch screen, and the like), a printer, or any other suitable means for outputting data for visual depiction, such as a table, chart, or graph. The means for processing, means for outputting, or means for determining may comprise a processing system, which may include one or more processors or processing units. Means for storing may comprise a memory or any other suitable storage device (e.g., RAM), which may be accessed by the processing system.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of a, b, or c” is intended to cover a, b, c, a-b, a-c, b-c, and a-b-c.

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface, supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for neural networks, comprising:
determining a first state of a neuron model, wherein the neuron model has a closed-form solution in continuous time and wherein state dynamics of the neuron model are divided into two or more regimes; and
determining an operating regime for the neuron model from the two or more regimes, based on the first state.

2. The method of claim 1, wherein the two or more regimes comprise first and second regimes and wherein the state dynamics of the neuron model tend toward rest in the first regime and tend toward spiking in the second regime.

3. The method of claim 1, wherein the two or more regimes comprise first and second regimes and wherein the state dynamics of the neuron model tends toward a first reference in a first regime and tend away from a second reference in a second regime.

4. The method of claim 3, wherein the first or the second reference comprises at least one of a point, a line, or a plane.

5. The method of claim 1, wherein the two or more regimes comprise first and second regimes and wherein the state dynamics of the neuron model exhibit leaky-integrate-and-fire (LIF) behavior in the first regime and exhibit anti-leaky-integrate-and-fire (ALIF) behavior in the second regime.

6. The method of claim 1, wherein the two or more regimes comprise first and second regimes, wherein in the first regime the neuron model begins losing memory of a prior input after receiving the prior input and wherein in the second regime the neuron model will fire, even with no further excitatory input, such that further excitatory or inhibitory input affects only when the neuron model will fire.

7. The method of claim 1, further comprising determining a second state of the neuron model at a different time than that of the first state, based on at least one of the first state and the operating regime.

8. The method of claim 7, wherein the first state of the neuron model corresponds to a first event, wherein the second state corresponds to a second event, and wherein the second event is the next event after the first event.

9. The method of claim 8, wherein determining the second state comprises determining the second state of the neuron model based on a time between the first event and the second event and on the state dynamics in the operating regime.

10. The method of claim 7, wherein the first state comprises a current state of the neuron model and wherein the second state comprises a future state after the current state or a prior state before the current state.

11. The method of claim 7, wherein the first state comprises a prior state of the neuron model and wherein the second state comprises a current state or a future state, after the prior state.

12. The method of claim 7, wherein the first event comprises an input event, an output event, or an artificial event for the neuron model.

13. The method of claim 7, wherein the first state is defined by a membrane potential (ν) and a recovery current (u) of the neuron model and wherein determining the second state comprises using the following equations:
$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$
$$r = δ ( v + ɛ )$$
where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, ν_{ρ} is a base voltage for the operating regime, q_{ρ} and r are state transformation variables, δ is a scale factor, and ε is an offset voltage.

14. The method of claim 1, further comprising determining when the neuron model will fire based on at least one of the first state and the operating regime.

15. The method of claim 14, wherein the first state is defined by a membrane potential (ν) and a recovery current (u) of the neuron model and wherein determining when the neuron model will fire comprises using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

16. The method of claim 14, wherein determining when the neuron model will fire comprises using the state dynamics of the neuron model, decoupled from any events.

17. The method of claim 14, further comprising outputting a spike at an output time according to the determination of when the neuron model will fire.

18. The method of claim 1, wherein determining the first state comprises determining the first state after a predetermined period if the neuron model does not receive any event during the period.

19. The method of claim 1, wherein determining the operating regime comprises determining the operating regime at or shortly after a time of an event.

20. The method of claim 1, wherein the state dynamics are defined by a membrane potential and a recovery current of the neuron model.

21. The method of claim 1, further comprising determining, at or shortly after a time of an event, state transformation variables, wherein at least one of the state transformation variables is dependent on the operating regime.

22. The method of claim 21, further comprising determining a second state of the neuron model at a different time than that of the first state, based on the first state and the state transformation variables.

23. The method of claim 21, wherein the state dynamics of the neuron model are expressed as ordinary differential equations (ODEs) based on the state transformation variables between events.

24. The method of claim 1, further comprising outputting the first state of the neuron model to a display.

25. An apparatus for neural networks, comprising:
a processing system configured to:
determine a first state of a neuron model, wherein the neuron model has a closed-form solution in continuous time and wherein state dynamics of the neuron model are divided into two or more regimes; and
determine an operating regime for the neuron model from the two or more regimes, based on the first state.

26. The apparatus of claim 25, wherein the two or more regimes comprise first and second regimes and wherein the state dynamics of the neuron model tend toward rest in the first regime and tend toward spiking in the second regime.

27. The apparatus of claim 25, wherein the two or more regimes comprise first and second regimes and wherein the state dynamics of the neuron model tends toward a first reference in a first regime and tend away from a second reference in a second regime.

28. The apparatus of claim 27, wherein the first or the second reference comprises at least one of a point, a line, or a plane.

29. The apparatus of claim 25, wherein the two or more regimes comprise first and second regimes and wherein the state dynamics of the neuron model exhibit leaky-integrate-and-fire (LIF) behavior in the first regime and exhibit anti-leaky-integrate-and-fire (ALIF) behavior in the second regime.

30. The apparatus of claim 25, wherein the two or more regimes comprise first and second regimes, wherein in the first regime the neuron model begins losing memory of a prior input after receiving the prior input and wherein in the second regime the neuron model will fire, even with no further excitatory input, such that further excitatory or inhibitory input affects only when the neuron model will fire.

31. The apparatus of claim 25, wherein the processing system is further configured to determine a second state of the neuron model at a different time than that of the first state, based on at least one of the first state and the operating regime.

32. The apparatus of claim 31, wherein the first state of the neuron model corresponds to a first event, wherein the second state corresponds to a second event, and wherein the second event is the next event after the first event.

33. The apparatus of claim 32, wherein the processing system is configured to determine the second state by determining the second state of the neuron model based on a time between the first event and the second event and on the state dynamics in the operating regime.

34. The apparatus of claim 31, wherein the first state comprises a current state of the neuron model and wherein the second state comprises a future state after the current state or a prior state before the current state.

35. The apparatus of claim 31, wherein the first state comprises a prior state of the neuron model and wherein the second state comprises a current state or a future state, after the prior state.

36. The apparatus of claim 31, wherein the first event comprises an input event, an output event, or an artificial event for the neuron model.

37. The apparatus of claim 31, wherein the first state is defined by a membrane potential (ν) and a recovery current (u) of the neuron model and wherein the processing system is configured to determine the second state by using the following equations:
$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$
$$r = δ ( v + ɛ )$$
where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, ν_{ρ} is a base voltage for the operating regime, q_{ρ} and r are state transformation variables, δ is a scale factor, and ε is an offset voltage.

38. The apparatus of claim 25, wherein the processing system is further configured to determine when the neuron model will fire based on at least one of the first state and the operating regime.

39. The apparatus of claim 38, wherein the first state is defined by a membrane potential (ν) and a recovery current (u) of the neuron model and wherein the processing system is configured to determine when the neuron model will fire by using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

40. The apparatus of claim 38, wherein the processing system is configured to determine when the neuron model will fire by using the state dynamics of the neuron model, decoupled from any events.

41. The apparatus of claim 38, wherein the processing system is further configured to output a spike at an output time according to the determination of when the neuron model will fire.

42. The apparatus of claim 25, wherein the processing system is configured to determine the first state by determining the first state after a predetermined period if the neuron model does not receive any event during the period.

43. The apparatus of claim 25, wherein the processing system is configured to determine the operating regime by determining the operating regime at or shortly after a time of an event.

44. The apparatus of claim 25, wherein the state dynamics are defined by a membrane potential and a recovery current of the neuron model.

45. The apparatus of claim 25, wherein the processing system is further configured to determine, at or shortly after a time of an event, state transformation variables, wherein at least one of the state transformation variables is dependent on the operating regime.

46. The apparatus of claim 45, wherein the processing system is further configured to determine a second state of the neuron model at a different time than that of the first state, based on the first state and the state transformation variables.

47. The apparatus of claim 45, wherein the state dynamics of the neuron model are expressed as ordinary differential equations (ODEs) based on the state transformation variables between events.

48. An apparatus for neural networks, comprising:
means for determining a first state of a neuron model, wherein the neuron model has a closed-form solution in continuous time and wherein state dynamics of the neuron model are divided into two or more regimes; and
means for determining an operating regime for the neuron model from the two or more regimes, based on the first state.

49. The apparatus of claim 48, wherein the two or more regimes comprise first and second regimes and wherein the state dynamics of the neuron model tend toward rest in the first regime and tend toward spiking in the second regime.

50. The apparatus of claim 48, wherein the two or more regimes comprise first and second regimes and wherein the state dynamics of the neuron model tends toward a first reference in a first regime and tend away from a second reference in a second regime.

51. The apparatus of claim 50, wherein the first or the second reference comprises at least one of a point, a line, or a plane.

52. The apparatus of claim 48, wherein the two or more regimes comprise first and second regimes and wherein the state dynamics of the neuron model exhibit leaky-integrate-and-fire (LIF) behavior in the first regime and exhibit anti-leaky-integrate-and-fire (ALIF) behavior in the second regime.

53. The apparatus of claim 48, wherein the two or more regimes comprise first and second regimes, wherein in the first regime the neuron model begins losing memory of a prior input after receiving the prior input and wherein in the second regime the neuron model will fire, even with no further excitatory input, such that further excitatory or inhibitory input affects only when the neuron model will fire.

54. The apparatus of claim 48, further comprising means for determining a second state of the neuron model at a different time than that of the first state, based on at least one of the first state and the operating regime.

55. The apparatus of claim 54, wherein the first state of the neuron model corresponds to a first event, wherein the second state corresponds to a second event, and wherein the second event is the next event after the first event.

56. The apparatus of claim 55, wherein the means for determining the second state is configured to determine the second state of the neuron model based on a time between the first event and the second event and on the state dynamics in the operating regime.

57. The apparatus of claim 54, wherein the first state comprises a current state of the neuron model and wherein the second state comprises a future state after the current state or a prior state before the current state.

58. The apparatus of claim 54, wherein the first state comprises a prior state of the neuron model and wherein the second state comprises a current state or a future state, after the prior state.

59. The apparatus of claim 54, wherein the first event comprises an input event, an output event, or an artificial event for the neuron model.

60. The apparatus of claim 54, wherein the first state is defined by a membrane potential (ν) and a recovery current (u) of the neuron model and wherein the means for determining the second state is configured to use the following equations:
$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$
$$r = δ ( v + ɛ )$$
where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, τ_{ρ} is a base voltage for the operating regime, q_{ρ} and r are state transformation variables, δ is a scale factor, and ε is an offset voltage.

61. The apparatus of claim 48, further comprising means for determining when the neuron model will fire based on at least one of the first state and the operating regime.

62. The apparatus of claim 61, wherein the first state is defined by a membrane potential (ν) and a recovery current (u) of the neuron model and wherein the means for determining when the neuron model will fire is configured to use the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

63. The apparatus of claim 61, wherein the means for determining when the neuron model will fire is configured to use the state dynamics of the neuron model, decoupled from any events.

64. The apparatus of claim 61, further comprising means for outputting a spike at an output time according to the determination of when the neuron model will fire.

65. The apparatus of claim 48, wherein the means for determining the first state is configured to determine the first state after a predetermined period if the neuron model does not receive any event during the period.

66. The apparatus of claim 48, wherein the means for determining the operating regime is configured to determine the operating regime at or shortly after a time of an event.

67. The apparatus of claim 48, wherein the state dynamics are defined by a membrane potential and a recovery current of the neuron model.

68. The apparatus of claim 48, further comprising means for determining, at or shortly after a time of an event, state transformation variables, wherein at least one of the state transformation variables is dependent on the operating regime.

69. The apparatus of claim 68, further comprising means for determining a second state of the neuron model at a different time than that of the first state, based on the first state and the state transformation variables.

70. The apparatus of claim 68, wherein the state dynamics of the neuron model are expressed as ordinary differential equations (ODEs) based on the state transformation variables between events.

71. A computer program product for neural networks, comprising a computer-readable medium comprising instructions executable to:
determine a first state of a neuron model, wherein the neuron model has a closed-form solution in continuous time and wherein state dynamics of the neuron model are divided into two or more regimes; and
determine an operating regime for the neuron model from the two or more regimes, based on the first state.

72. The computer program product of claim 71, wherein the two or more regimes comprise first and second regimes and wherein the state dynamics of the neuron model tend toward rest in the first regime and tend toward spiking in the second regime.

73. The computer program product of claim 71, wherein the two or more regimes comprise first and second regimes and wherein the state dynamics of the neuron model tends toward a first reference in a first regime and tend away from a second reference in a second regime.

74. The computer program product of claim 73, wherein the first or the second reference comprises at least one of a point, a line, or a plane.

75. The computer program product of claim 71, wherein the two or more regimes comprise first and second regimes and wherein the state dynamics of the neuron model exhibit leaky-integrate-and-fire (LIF) behavior in the first regime and exhibit anti-leaky-integrate-and-fire (ALIF) behavior in the second regime.

76. The computer program product of claim 71, wherein the two or more regimes comprise first and second regimes, wherein in the first regime the neuron model begins losing memory of a prior input after receiving the prior input and wherein in the second regime the neuron model will fire, even with no further excitatory input, such that further excitatory or inhibitory input affects only when the neuron model will fire.

77. The computer program product of claim 71, further comprising instructions executable to determine a second state of the neuron model at a different time than that of the first state, based on at least one of the first state and the operating regime.

78. The computer program product of claim 77, wherein the first state of the neuron model corresponds to a first event, wherein the second state corresponds to a second event, and wherein the second event is the next event after the first event.

79. The computer program product of claim 78, wherein determining the second state comprises determining the second state of the neuron model based on a time between the first event and the second event and on the state dynamics in the operating regime.

80. The computer program product of claim 77, wherein the first state comprises a current state of the neuron model and wherein the second state comprises a future state after the current state or a prior state before the current state.

81. The computer program product of claim 77, wherein the first state comprises a prior state of the neuron model and wherein the second state comprises a current state or a future state, after the prior state.

82. The computer program product of claim 77, wherein the first event comprises an input event, an output event, or an artificial event for the neuron model.

83. The computer program product of claim 77, wherein the first state is defined by a membrane potential (ν) and a recovery current (u) of the neuron model and wherein determining the second state comprises using the following equations:
$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$
$$r = δ ( v + ɛ )$$
where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, ν_{ρ} is a base voltage for the operating regime, q_{ρ} and r are state transformation variables, δ is a scale factor, and ε is an offset voltage.

84. The computer program product of claim 71, further comprising instructions executable to determine when the neuron model will fire based on at least one of the first state and the operating regime.

85. The computer program product of claim 84, wherein the first state is defined by a membrane potential (ν) and a recovery current (u) of the neuron model and wherein determining when the neuron model will fire comprises using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

86. The computer program product of claim 84, wherein determining when the neuron model will fire comprises using the state dynamics of the neuron model, decoupled from any events.

87. The computer program product of claim 84, further comprising instructions executable to output a spike at an output time according to the determination of when the neuron model will fire.

88. The computer program product of claim 71, wherein determining the first state comprises determining the first state after a predetermined period if the neuron model does not receive any event during the period.

89. The computer program product of claim 71, wherein determining the operating regime comprises determining the operating regime at or shortly after a time of an event.

90. The computer program product of claim 71, wherein the state dynamics are defined by a membrane potential and a recovery current of the neuron model.

91. The computer program product of claim 71, further comprising instructions executable to determine, at or shortly after a time of an event, state transformation variables, wherein at least one of the state transformation variables is dependent on the operating regime.

92. The computer program product of claim 91, further comprising instructions executable to determine a second state of the neuron model at a different time than that of the first state, based on the first state and the state transformation variables.

93. The computer program product of claim 91, wherein the state dynamics of the neuron model are expressed as ordinary differential equations (ODEs) based on the state transformation variables between events.

94. A method for neural networks, comprising:
determining a first state of a neuron model at or shortly after a first event, wherein the neuron model has a closed-form solution in continuous time; and
determining a second state of the neuron model at or shortly after a second event, based on the first state, wherein dynamics of the first and second states are coupled to the neuron model only at the first and second events, respectively, and are decoupled between the first and second events.

95. The method of claim 94, wherein the first and second states are multivariate.

96. The method of claim 94, wherein the second event comprises an input event, an output event, or an artificial event.

97. The method of claim 94, wherein the first or the second state is defined by two or more state variables whose dynamics are decoupled between the events and coupled at the events through transformations.

98. The method of claim 94, wherein the second event is the next event after the first event.

99. The method of claim 94, wherein the first state comprises a current state of the neuron model and wherein the second state comprises a future state after the current state or a prior state before the current state.

100. The method of claim 94, wherein the first state comprises a prior state of the neuron model and wherein the second state comprises a current state or a future state, after the prior state.

101. The method of claim 94, wherein the first state is defined by a membrane potential (ν) and a recovery current (u) of the neuron model and wherein determining the second state comprises using the following equations:
$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$
$$r = δ ( v + ɛ )$$
where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, ν_{ρ} is a base voltage for an operating regime, q_{ρ} and r are state transformation variables, δ is a scale factor, and ε is an offset voltage.

102. The method of claim 94, further comprising determining when the neuron model will fire based on at least one of the first state or the second state.

103. The method of claim 102, wherein at least one of the first state or the second state is defined by a membrane potential (ν) and a recovery current (u) of the neuron model and wherein determining when the neuron model will fire comprises using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

104. The method of claim 102, wherein determining when the neuron model will fire comprises using the dynamics of the first and second states.

105. The method of claim 102, further comprising outputting a spike at an output time according to the determination of when the neuron model will fire.

106. The method of claim 94, wherein determining at least one of the first state or the second state comprises determining the at least one of the first state or the second state after a predetermined period if the neuron model does not receive any event during the period.

107. The method of claim 94, wherein the dynamics of the first and second states are expressed as ordinary differential equations (ODEs) based on state transformation variables between events.

108. The method of claim 94, further comprising outputting at least one of the first state, the second state, a first indication of the first event, or a second indication of the second event to a display.

109. An apparatus for neural networks, comprising:
a processing system configured to:
determine a first state of a neuron model at or shortly after a first event, wherein the neuron model has a closed-form solution in continuous time; and
determine a second state of the neuron model at or shortly after a second event, based on the first state, wherein dynamics of the first and second states are coupled to the neuron model only at the first and second events, respectively, and are decoupled between the first and second events.

110. The apparatus of claim 109, wherein the first and second states are multivariate.

111. The apparatus of claim 109, wherein the second event comprises an input event, an output event, or an artificial event.

112. The apparatus of claim 109, wherein the first or the second state is defined by two or more state variables whose dynamics are decoupled between the events and coupled at the events through transformations.

113. The apparatus of claim 109, wherein the second event is the next event after the first event.

114. The apparatus of claim 109, wherein the first state comprises a current state of the neuron model and wherein the second state comprises a future state after the current state or a prior state before the current state.

115. The apparatus of claim 109, wherein the first state comprises a prior state of the neuron model and wherein the second state comprises a current state or a future state, after the prior state.

116. The apparatus of claim 109, wherein the first state is defined by a membrane potential (ν) and a recovery current (u) of the neuron model and wherein the processing system is configured to determine the second state by using the following equations:
$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$
$$r = δ ( v + ɛ )$$
where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, ν_{ρ} is a base voltage for an operating regime, q_{ρ} and r are state transformation variables, δ is a scale factor, and ε is an offset voltage.

117. The apparatus of claim 109, wherein the processing system is further configured to determine when the neuron model will fire based on at least one of the first state or the second state.

118. The apparatus of claim 117, wherein at least one of the first state or the second state is defined by a membrane potential (ν) and a recovery current (u) of the neuron model and wherein the processing system is configured to determine when the neuron model will fire by using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

119. The apparatus of claim 117, wherein the processing system is configured to determine when the neuron model will fire by using the dynamics of the first and second states.

120. The apparatus of claim 117, wherein the processing system is further configured to output a spike at an output time according to the determination of when the neuron model will fire.

121. The apparatus of claim 109, wherein the processing system is configured to determine at least one of the first state or the second state by determining the at least one of the first state or the second state after a predetermined period if the neuron model does not receive any event during the period.

122. The apparatus of claim 109, wherein the dynamics of the first and second states are expressed as ordinary differential equations (ODEs) based on state transformation variables between events.

123. An apparatus for neural networks, comprising:
means for determining a first state of a neuron model at or shortly after a first event, wherein the neuron model has a closed-form solution in continuous time; and
means for determining a second state of the neuron model at or shortly after a second event, based on the first state, wherein dynamics of the first and second states are coupled to the neuron model only at the first and second events, respectively, and are decoupled between the first and second events.

124. The apparatus of claim 123, wherein the first and second states are multivariate.

125. The apparatus of claim 123, wherein the second event comprises an input event, an output event, or an artificial event.

126. The apparatus of claim 123, wherein the first or the second state is defined by two or more state variables whose dynamics are decoupled between the events and coupled at the events through transformations.

127. The apparatus of claim 123, wherein the second event is the next event after the first event.

128. The apparatus of claim 123, wherein the first state comprises a current state of the neuron model and wherein the second state comprises a future state after the current state or a prior state before the current state.

129. The apparatus of claim 123, wherein the first state comprises a prior state of the neuron model and wherein the second state comprises a current state or a future state, after the prior state.

130. The apparatus of claim 123, wherein the first state is defined by a membrane potential (ν) and a recovery current (u) of the neuron model and wherein the means for determining the second state is configured to use the following equations:
$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$
$$r = δ ( v + ɛ )$$
where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, ν_{ρ} is a base voltage for an operating regime, q_{ρ} and r are state transformation variables, δ is a scale factor, and ε is an offset voltage.

131. The apparatus of claim 123, further comprising means for determining when the neuron model will fire based on at least one of the first state or the second state.

132. The apparatus of claim 131, wherein at least one of the first state or the second state is defined by a membrane potential (ν) and a recovery current (u) of the neuron model and wherein the means for determining when the neuron model will fire is configured to use the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

133. The apparatus of claim 131, wherein the means for determining when the neuron model will fire is configured to use the dynamics of the first and second states.

134. The apparatus of claim 131, further comprising means for outputting a spike at an output time according to the determination of when the neuron model will fire.

135. The apparatus of claim 123, wherein the means for determining at least one of the first state or the second state is configured to determine the at least one of the first state or the second state after a predetermined period if the neuron model does not receive any event during the period.

136. The apparatus of claim 123, wherein the dynamics of the first and second states are expressed as ordinary differential equations (ODEs) based on state transformation variables between events.

137. A computer program product for neural networks, comprising a computer-readable medium comprising instructions executable to:
determine a first state of a neuron model at or shortly after a first event, wherein the neuron model has a closed-form solution in continuous time; and
determine a second state of the neuron model at or shortly after a second event, based on the first state, wherein dynamics of the first and second states are coupled to the neuron model only at the first and second events, respectively, and are decoupled between the first and second events.

138. The computer program product of claim 137, wherein the first and second states are multivariate.

139. The computer program product of claim 137, wherein the second event comprises an input event, an output event, or an artificial event.

140. The computer program product of claim 137, wherein the first or the second state is defined by two or more state variables whose dynamics are decoupled between the events and coupled at the events through transformations.

141. The computer program product of claim 137, wherein the second event is the next event after the first event.

142. The computer program product of claim 137, wherein the first state comprises a current state of the neuron model and wherein the second state comprises a future state after the current state or a prior state before the current state.

143. The computer program product of claim 137, wherein the first state comprises a prior state of the neuron model and wherein the second state comprises a current state or a future state, after the prior state.

144. The computer program product of claim 137, wherein the first state is defined by a membrane potential (ν) and a recovery current (u) of the neuron model and wherein determining the second state comprises using the following equations:
$${v}^{′} ( t + Δ t ) = {v}^{′} ( t ) {e}^{\frac{Δ t}{{τ }_{ρ}}} , \\ {u}^{′} ( t + Δ t ) = {u}^{′} ( t ) {e}^{- \frac{Δ t}{{τ}_{u}}} , \\ {v}^{′} = v + {q}_{ρ} , \\ {u}^{′} = u + r , \\ {q}_{ρ} = - {τ}_{ρ} {β}_{u} - {v}_{ρ} , and$$
$$r = δ ( v + ɛ )$$
where Δt is an elapsed time between the first and second states, ρ=+if ν>\hat{ν}₊, ρ=−if ν≦\hat{ν}₊, \hat{ν}₊ is a regime threshold, τ_{ρ} is a voltage time constant, τᵤ is a recovery current time constant, β is a resistance, ν_{ρ} is a base voltage for an operating regime, q_{ρ} and r are state transformation variables, δ is a scale factor, and ε is an offset voltage.

145. The computer program product of claim 137, further comprising instructions executable to determine when the neuron model will fire based on at least one of the first state or the second state.

146. The computer program product of claim 145, wherein at least one of the first state or the second state is defined by a membrane potential (ν) and a recovery current (u) of the neuron model and wherein determining when the neuron model will fire comprises using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

147. The computer program product of claim 145, wherein determining when the neuron model will fire comprises using the dynamics of the first and second states.

148. The computer program product of claim 145, further comprising instructions executable to output a spike at an output time according to the determination of when the neuron model will fire.

149. The computer program product of claim 137, wherein determining at least one of the first state or the second state comprises determining the at least one of the first state or the second state after a predetermined period if the neuron model does not receive any event during the period.

150. The computer program product of claim 137, wherein the dynamics of the first and second states are expressed as ordinary differential equations (ODEs) based on state transformation variables between events.

151. A method for neural networks, comprising:
determining a first state of a neuron model at or shortly after a first event, wherein the neuron model has a closed-form solution in continuous time; and
determining a second event when, if ever, a second state of the neuron model will occur, based on the first state, wherein dynamics of the first and second states are coupled to the neuron model only at the first and second events, respectively, and are decoupled between the first and second events.

152. The method of claim 151, wherein the first and second states are multivariate.

153. The method of claim 151, wherein the second event comprises an input event, an output event, or an artificial event.

154. The method of claim 151, wherein the second event is the next event after the first event.

155. The method of claim 151, wherein the first state comprises a current state of the neuron model and wherein the second state comprises a future state after the current state or a prior state before the current state.

156. The method of claim 151, wherein the first state comprises a prior state of the neuron model and wherein the second state comprises a current state or a future state, after the prior state.

157. The method of claim 151, wherein the first state is defined by a membrane potential (ν) and a recovery current (u) of the neuron model and wherein determining the second event comprises using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

158. The method of claim 151, further comprising outputting a spike at an output time according to the determination of the second event.

159. The method of claim 151, wherein determining the first state comprises determining the first state after a predetermined period if the neuron model does not receive any event during the period.

160. The method of claim 151, wherein the dynamics of the first and second states are expressed as ordinary differential equations (ODEs) based on state transformation variables between the first and second events.

161. The method of claim 151, further comprising outputting at least one of the first state, the second state, a first indication of the first event, or a second indication of the second event to a display.

162. An apparatus for neural networks, comprising:
a processing system configured to:
determine a first state of a neuron model at or shortly after a first event, wherein the neuron model has a closed-form solution in continuous time; and
determine a second event when, if ever, a second state of the neuron model will occur, based on the first state, wherein dynamics of the first and second states are coupled to the neuron model only at the first and second events, respectively, and are decoupled between the first and second events.

163. The apparatus of claim 162, wherein the first and second states are multivariate.

164. The apparatus of claim 162, wherein the second event comprises an input event, an output event, or an artificial event.

165. The apparatus of claim 162, wherein the second event is the next event after the first event.

166. The apparatus of claim 162, wherein the first state comprises a current state of the neuron model and wherein the second state comprises a future state after the current state or a prior state before the current state.

167. The apparatus of claim 162, wherein the first state comprises a prior state of the neuron model and wherein the second state comprises a current state or a future state, after the prior state.

168. The apparatus of claim 162, wherein the first state is defined by a membrane potential (ν) and a recovery current (u) of the neuron model and wherein the processing system is configured to determine the second event by using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

169. The apparatus of claim 162, wherein the processing system is further configured to output a spike at an output time according to the determination of the second event.

170. The apparatus of claim 162, wherein the processing system is configured to determine the first state by determining the first state after a predetermined period if the neuron model does not receive any event during the period.

171. The apparatus of claim 162, wherein the dynamics of the first and second states are expressed as ordinary differential equations (ODEs) based on state transformation variables between the first and second events.

172. An apparatus for neural networks, comprising:
means for determining a first state of a neuron model at or shortly after a first event, wherein the neuron model has a closed-form solution in continuous time; and
means for determining a second event when, if ever, a second state of the neuron model will occur, based on the first state, wherein dynamics of the first and second states are coupled to the neuron model only at the first and second events, respectively, and are decoupled between the first and second events.

173. The apparatus of claim 172, wherein the first and second states are multivariate.

174. The apparatus of claim 172, wherein the second event comprises an input event, an output event, or an artificial event.

175. The apparatus of claim 172, wherein the second event is the next event after the first event.

176. The apparatus of claim 172, wherein the first state comprises a current state of the neuron model and wherein the second state comprises a future state after the current state or a prior state before the current state.

177. The apparatus of claim 172, wherein the first state comprises a prior state of the neuron model and wherein the second state comprises a current state or a future state, after the prior state.

178. The apparatus of claim 172, wherein the first state is defined by a membrane potential (ν) and a recovery current (u) of the neuron model and wherein the means for determining the second event is configured to use the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

179. The apparatus of claim 172, further comprising means for outputting a spike at an output time according to the determination of the second event.

180. The apparatus of claim 172, wherein the means for determining the first state is configured to determine the first state after a predetermined period if the neuron model does not receive any event during the period.

181. The apparatus of claim 172, wherein the dynamics of the first and second states are expressed as ordinary differential equations (ODEs) based on state transformation variables between the first and second events.

182. A computer program product for neural networks, comprising a computer-readable medium comprising instructions executable to:
determine a first state of a neuron model at or shortly after a first event, wherein the neuron model has a closed-form solution in continuous time; and
determine a second event when, if ever, a second state of the neuron model will occur, based on the first state, wherein dynamics of the first and second states are coupled to the neuron model only at the first and second events, respectively, and are decoupled between the first and second events.

183. The computer program product of claim 182, wherein the first and second states are multivariate.

184. The computer program product of claim 182, wherein the second event comprises an input event, an output event, or an artificial event.

185. The computer program product of claim 182, wherein the second event is the next event after the first event.

186. The computer program product of claim 182, wherein the first state comprises a current state of the neuron model and wherein the second state comprises a future state after the current state or a prior state before the current state.

187. The computer program product of claim 182, wherein the first state comprises a prior state of the neuron model and wherein the second state comprises a current state or a future state, after the prior state.

188. The computer program product of claim 182, wherein the first state is defined by a membrane potential (ν) and a recovery current (u) of the neuron model and wherein determining the second event comprises using the following rule:
$$Δ {t}_{s} = \{ \begin{matrix}{τ}_{+} log \frac{{v}_{s} + {q}_{+}}{v + {q}_{+}} & if v > {\hat{v}}_{+} \\ ∞ & otherwise\end{matrix} \}$$
where τ₊ is a positive regime voltage time constant, νₛ is a defined voltage of an output spike of the neuron model, q₊ is a positive regime state transformation variable, \hat{ν}₊ is a regime threshold and Δtₛ is an anticipated time until the neuron model will fire.

189. The computer program product of claim 182, further comprising instructions executable to output a spike at an output time according to the determination of the second event.

190. The computer program product of claim 182, wherein determining the first state comprises determining the first state after a predetermined period if the neuron model does not receive any event during the period.

191. The computer program product of claim 182, wherein the dynamics of the first and second states are expressed as ordinary differential equations (ODEs) based on state transformation variables between the first and second events.

192. The method of claim 1, wherein the neuron model has a variable coincidence detection window.

193. The apparatus of claim 25, wherein the neuron model has a variable coincidence detection window.

194. The apparatus of claim 48, wherein the neuron model has a variable coincidence detection window.

195. The computer program product of claim 71, wherein the neuron model has a variable coincidence detection window.

196. The method of claim 94, wherein the neuron model has a variable coincidence detection window.

197. The apparatus of claim 109, wherein the neuron model has a variable coincidence detection window.

198. The apparatus of claim 123, wherein the neuron model has a variable coincidence detection window.

199. The computer program product of claim 137, wherein the neuron model has a variable coincidence detection window.

200. The method of claim 151, wherein the neuron model has a variable coincidence detection window.

201. The apparatus of claim 162, wherein the neuron model has a variable coincidence detection window.

202. The apparatus of claim 172, wherein the neuron model has a variable coincidence detection window.

203. The computer program product of claim 182, wherein the neuron model has a variable coincidence detection window.
